(19) United States
(12) Patent Application Publication
(10) Pub. No.: US 2007/0133955 A1
(43) Pub. Date: Jun. 14, 2007

(54) Fan Speed Control Circuit Simultaneously Controlled By Temperature And PWM

(76) Inventors: Wen Fuang Hsu, Pan-Chiao City (TW); Steven Hu, Dong Guan City (CN); Solon Wu, Dong Guan City (CN)

Correspondence Address: HDSL, 4331 STEVENS BATTLE LANE, FAIRFAX, VA, 22033, US

(21) Appl. No.: 11/554,584

(22) Filed: Oct. 30, 2006

Related U.S. Application Data
(63) Continuation-in-part of application No. 11/297,369, filed on Dec. 9, 2005, now abandoned.

(51) Int. Cl. H02P 7/29

(52) U.S. Cl. 388/811

(57) ABSTRACT

A speed control circuit of a fan motor simultaneously controlled by temperature and PWM signals is provided. The PWM signals are received by a PWM control circuit, which sends a PWM control signal based on duty cycles of the PWM signals to a temperature detecting circuit. The temperature detecting circuit not only receives the PWM control signal and generates a temperature control signal according to the temperature around the fan motor, but also combines both the control signals to send a fan motor speed control signal to an amplifier. Then, the amplifier amplifies the fan motor speed control signal and transmits it to the controllable motor driving circuit. At last, the controllable motor driving circuit transfers the fan motor speed control signal into a fan motor driving signal in order to drive the fan motor.

### RELATED APPLICATIONS

This application is a continuation-in-part of U.S. patent application Ser. No. 11/297,369, filed Dec. 9, 2005, the entire subject of which is hereby incorporated herein by reference for all purposes.

### BACKGROUND OF THE INVENTION

1. Field of the Invention

This invention relates to heat dissipating fans, especially to speed control of heat dissipating fans.

2. Description of Prior Art

With the progress of computer technology, the requirements on computer performance are increasingly demanding. There are novel generations of Central Processing Units (CPUs) and other electronic devices which are produced. However, they also result in a serious problem. The growing heat generated by the CPUs and the other electronic devices makes the temperature on the motherboards increasing. And if the heat is not handled properly, the computers are unlikely to function normally and may be damaged now and then. In order to solve the problem, the computers often use heat dissipating fans to dissipate the surging heat generated by the CPUs and the other electronic devices.

Since the quality of the heat dissipation fans is closely related with the performance and the longevity of the computers, the users are demanding more when choosing heat dissipation fans, but typically the available heat dissipating fans are unable to fit the needs. That is because typically the available heat dissipating fan can only be operated at a fixed rotational speed and its rotational speed totally cannot be adjusted according to different situations. So, new types of heat dissipating fans are coming up in order to overcome the problem, such as temperature controlled fan and Pulse Width Modulation (PWM) controlled fan. Nevertheless, there is still much room left for improvement. Because the temperature controlled fan only relies on the environmental temperature to adjust the speed of the temperature controlled fan, it totally cannot be controlled from the user's end. And for the PWM controlled fan, it also cannot change the rotational speed of the heat dissipating fan according to the environmental temperature around the PWM controlled fan, so the heat dissipating fan cannot dissipate the heat as the environmental temperature around the PWM controlled fan increases. On account of the aforementioned room left for improvement, how to prevent the described disadvantages and combine both advantages of the heat dissipating fans makes one of the ordinary skills in the art desperately want to solve.

### SUMMARY OF THE INVENTION

The present invention is to provide a speed control circuit of a fan motor simultaneously controlled by temperature and PWM signals. The speed control circuit of a fan motor includes a PWM control circuit, a temperature detecting circuit, an amplifier, and a controllable motor driving circuit. When receiving PWM signals, the PWM control circuit sends a PWM control signal based on duty cycles of the PWM signals to the temperature detecting circuit. The temperature detecting circuit not only receives the PWM control signal and generates a temperature control signal based on environmental temperature, but also combines both the PWM control and the temperature control signals to send a fan motor speed control signal to the amplifier. Then, the amplifier receives and amplifies the fan motor speed control signal and transmits it to the controllable motor driving circuit. At last, the controllable motor driving circuit transfers the amplified fan motor speed control signal into a fan motor driving signal in order to drive the fan motor.

### BRIEF DESCRIPTION OF DRAWING

The features of the invention believed to be novel are set forth with particularity in the appended claims. The invention itself however may be best understood by reference to the following detailed description of the invention, which describes certain exemplary embodiments of the invention, taken in conjunction with the accompanying drawings in which: FIG. 1 shows the block diagram for a speed control circuit of a fan motor.

FIG. 2 shows the detailed circuit diagram for a speed control circuit of a fan motor.

### DETAILED DESCRIPTION OF THE INVENTION

Please refer to FIG. 1. FIG. 1 shows the block diagram for a speed control circuit of a fan motor. The speed control circuit of a fan motor mainly includes a PWM control circuit 102 (also including a lock and protection circuit 101 and a PWM switch 103.), a temperature detecting circuit 104, a filtering circuit 105 and a temperature compensation circuit 106, an amplifier 100 and a controllable motor driving circuit 120. When PWM signals 150 are inputted into the PWM control circuit 102, the lock and protection circuit 101 provides protection during the PWM switch 103 is switched between high and low. The PWM switch 103 is electrically connected to the lock and protection circuit 101. When duty cycles of the PWM signals 150 are changed, the ON/OFF states of the PWM switch 103 are switched. At this time, the PWM control circuit 102 sending a PWM control signal based on duty cycles of PWM signals 150 to the temperature detecting circuit 104.

The temperature detecting circuit 104, electrically connected to the PWM control circuit 102, not only receives and generates a temperature control signal according to the environmental temperature around the fan motor, but also combining both the PWM control signal and the temperature control signal to send a fan motor speed control signal to the filtering circuit 105. The filtering circuit 105, electrically connected to the temperature detecting circuit 104, filters the fan motor speed control signal and transits it to the amplifier 100.

The amplifier 100 is electrically connected to the filtering circuit 105 and the temperature compensation circuit 106. The temperature compensation circuit 106 provides temperature compensation for the amplifier 100. The amplifier 100 is to amplify the fan motor speed control signal and transit it to the controllable motor driving circuit 120. The controllable motor driving circuit 120, including a rotational speed limit circuit, transfers the amplified fan motor speed control signal from the amplifier 100 into a fan motor driving signal after speed limiting, in order to drive the fan motor.

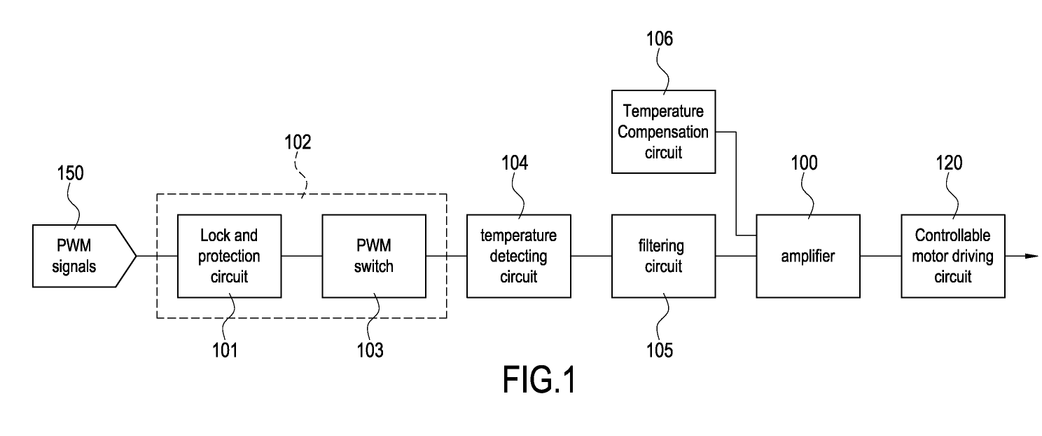

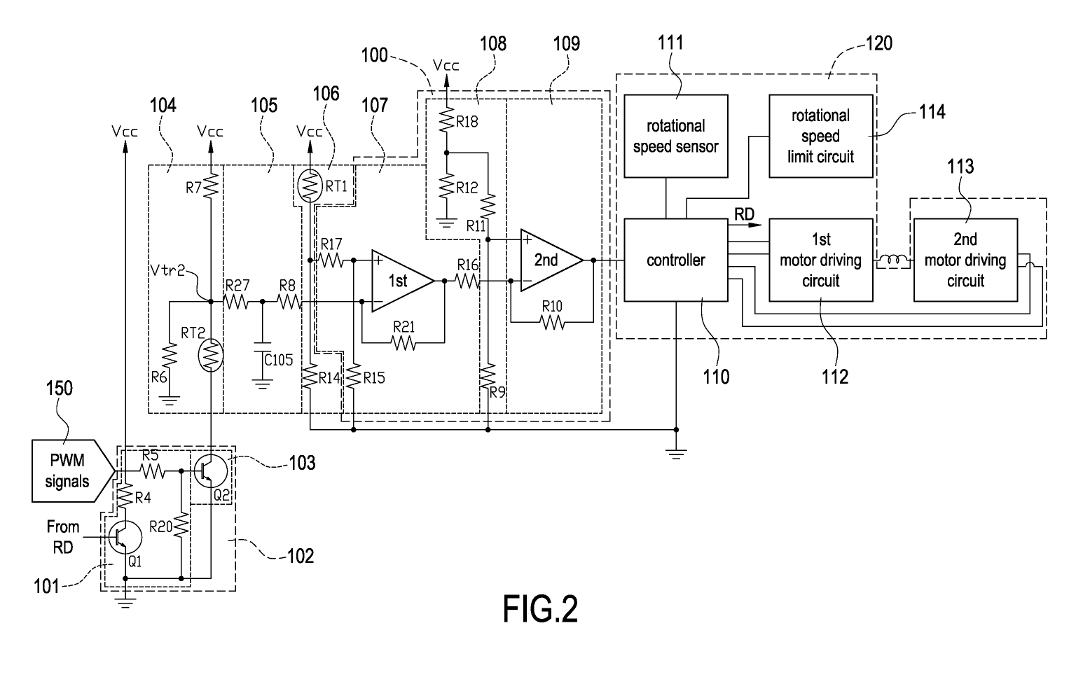

Please also refer to FIG. 2. FIG. 2 shows the detailed circuit diagram for a speed control circuit of a fan motor. The PWM signals 150 are inputted into the PWM control circuit 102. Within the PWM control circuit 102, it includes a lock and protection circuit 101 and a PWM switch 103 which is electrically connected to the lock and protection circuit 101. The lock and protection circuit 101 includes a transistor Q1, resistors R4, R5 and R20. The gate input end of the transistor Q1 is used to receive RD signals. When the fan motor is locked, the transistor Q1 being turned on, the PWM signals are sent to the ground and diminish in order to prevent the fan motor from being damaged due to large current. And the resistors R5 and R20 are to ensure the normal operation of the PWM switch 103, transistor Q2, when the voltage is switched between high and low.

The PWM switch 103, also electrically connected to the temperature detecting circuit 104, includes resistors R6, R7 and thermistor RT2. The thermistor RT2 detects the environmental temperature around the fan motor and adjusts its resistances according to the environmental temperature. Accordingly, the voltage Vtr2 determined by the changing resistances of the thermistor RT2 and the ON/OFF states of the transistor Q2 is provided to the filtering circuit 105.

The filtering circuit 105, electrically connected to the temperature detecting circuit 104, includes resistors R8, R27 and a capacitor C105. And the filtering circuit C105 filters the voltage Vtr2 and provides it to the negative input end of a 1^{st} OPAMP 130 of a fist amplifying circuit 107(including resistors R17, R15, R16, R21 and the 1^{st} OPAMP 130). The positive input end of the 1^{st} OPAMP 130 is electrically connected by resistors R17, R15 and the temperature compensation circuit 106.

The temperature compensation circuit 106 includes a resistor R14 and a thermistor RT1. The thermistor RT1 accordingly changes its resistances to modify the input voltage of the 1^{st} OPAMP 130 as the surrounding temperature varies. And, between the negative input end and output end of the 1^{st} OPAMP 130 is electrically connected by a negative feedback resistor R21. And, after comparing the voltage between the positive input end and the negative input end of the 1^{st} OPAMP 130, the output voltage is sent to the negative input end of a 2^{nd} OPAMP 140 of a 2^{nd} amplifying circuit 109 (including a resistor R10 and the 2^{nd} OPAMP 140) which is electrically connected to the 1^{st} OPAMP 130 through resistor R16. The positive input end of the 2^{nd} OPAMP 140 is electrically connected by an amplification ratio circuit 108. The amplification ratio circuit 108 is through resistors R9, R11, R12 and R18 in order to provide a reference voltage to the positive input end of the 2^{nd} OPAMP 140. Between the negative input end and output end of the 2^{nd} OPAMP 140 is electrically connected by a negative feedback resistor R10. Accordingly, after comparing the voltage between the positive input end and the negative input end of the 2^{nd} OPAMP 140, the output voltage is sent to the controllable motor driving circuit 120.

The controllable motor driving circuit 120 includes a controller 110, a rotational speed sensor 111, a rotational speed limit circuit 114, a first motor driving circuit 112 and a second motor amplifying circuit 113. The controller 110 is electrically connected to the rotational speed sensor 111. The rotational speed sensor 11I is preferred when it is a hall element. It is fixed to the side of the fan motor and detects the speed of the fan motor. The controller 110 utilizes the detected result to send the RD signals to gate input of the transistor Q1. The controller 110 sends a fan motor driving signal based on the variance of the amplified output voltage from the amplifier 100 to the 1^{st} motor driving circuit 112 and the 2^{nd} motor driving circuit 113. The controller 110 is also electrically connected to the rotational speed limit circuit 114, which limits the fan motor driving signal in order to keep the fan motor operated at a normal speed region. The 1^{st} motor driving circuit 112 and the 2^{nd} motor driving circuit 113, electrically connected to the controller 110 through electrical lines A, B, C and D, utilizes the fan motor driving signal to complementarily turn ON/OFF in order to drive the fan motor.

To sum up, the preferred embodiment of this invention exhibits the following functions. When the environmental temperature around the fan motor is changed, the speed of the fan motor is accordingly changed. Also, when duty cycles of the PWM signals are changed, the speed of the fan motor is responsively adjusted. To the contrary, if the temperature around the fan motor and the duty cycles of the PWM signals are not changed, the fan motor is operated at a normal speed. And the speed control circuit of the fan motor can be simultaneously controlled by PWM signals and the environmental temperature around the fan motor.

Although the present invention has been described with reference to the preferred embodiment thereof, it will be understood that the invention is not limited to the details thereof. Various substitutions and modifications have suggested in the foregoing description, and other will occur to those of ordinary skills in the art. All such substitutions and modifications are intended to be embraced within the scope of the invention as defined in the appended claims.

What is claimed is:

1. A speed control circuit of a fan motor, comprising:
a PWM control circuit receiving PWM signals and sending a PWM control signal based on duty cycles of the PWM signals;
a temperature detecting circuit electrically connected to the PWM control circuit, receiving the PWM control signal, for generating a temperature control signal based on an environmental temperature around the fan motor and combining both the PWM control and the temperature control signals to send a fan motor speed control signal;
an amplifier electrically connected to the temperature detecting circuit, for receiving and amplifying the fan motor speed control signal; and
a controllable motor driving circuit electrically connected between the amplifier and the fan motor, transferring the amplified fan motor speed control signal from the amplifier into a fan motor driving signal to drive the fan motor.

2. The speed control circuit of a fan motor of claim 1, wherein a filtering circuit is electrically connected between the temperature detecting circuit and the amplifier.

3. The speed control circuit of a fan motor of claim 2, wherein a temperature compensation circuit is electrically connected to the amplifier.

4. The speed control circuit of a fan motor of claim 3, wherein the temperature compensation circuit comprises a thermistor.

5. The speed control circuit of a fan motor of claim 1, wherein the amplifier is electrically to a temperature compensation circuit.

6. The speed control circuit of a fan motor of claim 5, wherein the temperature compensation circuit comprises a thermistor.

7. The speed control circuit of a fan motor of claim 1, wherein the PWM control circuit comprises a lock and protection circuit and a PWM switch, the lock and protection circuit being electrically connected to the PWM switch.

8. The speed control circuit of a fan motor of claim 7, wherein the PWM switch is a transistor.

9. The speed control circuit of a fan motor of claim 1, wherein the amplifier comprises a first amplifying circuit, an amplification ratio adjusting circuit and a second amplifying circuit, the first amplifying circuit and the amplification ratio adjusting circuit being electrically connected to the second amplifying circuit.

10. The speed control circuit of a fan motor of claim 1, wherein the temperature detecting circuit comprises a thermistor.

11. The speed control circuit of a fan motor of claim 1, the controllable motor driving circuit comprises a controller, a rotational speed limit circuit, a rotational speed sensor, a first motor driving circuit and a second motor driving circuit, the controller being electrically connected to the rotational speed sensor, the rotational speed limit circuit, the first motor driving circuit and the second motor driving circuit.
